(19) United States
(12) Patent Application Publication
(10) Pub. No.: US 2026/0076777 A1
(43) Pub. Date: Mar. 19, 2026

(54) DEVICE FOR PRODUCING A MOLDED PART OF A DENTAL SPLINT

(71) Applicant: GLANZIFY HAFTUNGSBESCHRÄNKT, Heidelberg (DE)

(72) Inventor: Akshay SHRISHRIMAL, Heidelberg (DE)

(73) Assignee: GLANZIFY HAFTUNGSBESCHRÄNKT, Heidelberg (DE)

(21) Appl. No.: 19/109,048

(22) PCT Filed: Aug. 15, 2023
(86) PCT No.: PCT/DE2023/200165

§ 371 Date: Mar. 5, 2025

(30) Foreign Application Priority Data
Sep. 6, 2022 (DE) 10 2022 209 272.4

(51) Int. Cl. A61C 7/08; B29C 51/18; B29L 31/00; B33Y 80/00

(52) U.S. Cl. CPC A61C 7/08; B29C 51/18; B29L 2031/753; B33Y 80/00

(57) ABSTRACT

A device for producing a molded part of a dental splint includes a base element, a retaining plate, and at least one receiving element. The at least one receiving element is arranged releasably on an upper side of the retaining plate. The at least one receiving element is designed to receive a tooth template. The at least one receiving element is fixable on the retaining plate in a plurality of positions and/or orientations. Also disclosed is an apparatus for producing a dental splint by such a device, and to a method for producing a dental splint, in particular using the apparatus.

The invention relates to a device for producing a molded part of a dental splint.

The invention further relates to a device for producing a dental splint.

In addition, the invention relates to a method for producing a dental splint.

For the correction of dental misalignments, it is known to affix fixed braces to the teeth. These braces apply tension to the teeth, guiding them into the desired alignment. Due to their unsightly impact on the appearance of the dentition and the significant discomfort they can cause, particularly in adults, fixed braces are primarily utilized for children and adolescents.

It is also known to utilize transparent splints—so-called aligners—to correct the misalignments. For this purpose, an impression of the dentition is first produced and digitally scanned. Based on this actual state, a target state is defined and a treatment path with several phases is determined.

For each phase, an individual dental splint is produced for the upper and lower jaws, which is worn for about two weeks. The dental splint exerts pressure on the teeth so that they move into the desired position.

To produce the dental splints, a digital 3D model of the dentition is first generated for each treatment phase and printed by means of a 3D printer. The printed 3D models are then utilized as a molded part, which are enveloped with a transparent plastic by means of a thermoforming process, so that a dental splint is created. Finally, the resulting splints are reworked, for example by polishing, cutting and cleaning. In this manner, individual splints are produced for each 3D printed model.

The drawback of this method is that a separate 3D model must be printed for each dental splint using the 3D printer. A treatment takes an average of 14 months, so that a total of 56 dental splints have to be produced for the upper and lower jaws and therefore 56 3D printed models have to be printed. This process is time-consuming and resource-intensive. With an estimated printing time of approximately 25 minutes and a material consumption of about 11.5 cm³ per 3D printed model, the entire process can take up to 24 hours and requires 667 cm³ of material.

Additionally, the process is cumbersome, as an operator must remove the splint every half hour and restart the procedure.

The present invention is therefore based on the object of specifying a device and a method, so that the expenditure of time and resources for the production of the dental splints is reduced.

According to the invention, the above object is achieved by the features of claim 1. According to this, a device for producing a molded part of a dental splint comprising a base element, a holding plate and at least one receiving element, preferably a plurality of receiving elements, is claimed, wherein the at least one receiving element is detachably arranged on an upper side of the holding plate, wherein the at least one receiving element is designed to receive a dental template, wherein the at least one receiving element can be fixed to the holding plate in a plurality of positions and/or orientations.

Furthermore, the above object is achieved according to the invention by the features of claim 8, according to which there is a device for producing a dental splint comprising a device according to one of claims 1 to 7, a positioning device for positioning the at least one receiving element and a thermoforming device for thermoforming a plastic blank.

Additionally, the aforementioned objective is accomplished through the features of claim 16, which outlines a method for producing a dental splint, particularly utilizing a device as described in one of claims 8 to 15, comprising the following steps:
Obtaining a plan for a positioning and/or arrangement of receiving elements, wherein a dental template is arranged on each of the receiving elements,
Placing and fixing the receiving elements on a top side of a holding plate based on the received plan, Production of the dental splint by thermoforming a plastic blank, wherein the placed receiving elements are used as a molded part for thermoforming.

In a manner according to the invention, it has been recognized that the molded part for the dental splint can be changed after thermoforming by a receiving element that can be fixed in a plurality of positions and/or orientations or a plurality of receiving elements with a dental template. Thus, receiving elements can be arranged in a first configuration and a first dental splint can be produced.

Subsequently, the receiving elements can be repositioned and/or reoriented, allowing for the creation of a new molded part that can be used for the production of a second dental splint. In this manner, all dental splints can be produced using the same dental template.

Within the scope of the claims and the description, a dental splint is to be understood in particular as an orthodontic object which can be arranged on the dentition of a user in order in particular to change the position and/or orientation of the teeth. It is also conceivable that the dental splint is designed as a bite splint, braces or reservoir for a bleaching agent, etc.

The “position and/or orientation” of the receiving element is to be understood in particular as the arrangement of the receiving elements in relation to the holding plate and/or to each other. In particular, this also includes a torsion, inclination, rotation and/or angulation of the receiving elements in relation to the holding plate and/or to each other.

The term “dental template” describes an artificial replica of a tooth. In particular, the dental template is designed to serve as a fit for the production of a dental splint enveloping a tooth. For example, a dental template can be made by scanning a tooth of a dentition and printing it by means of a 3D printer.

The term “holding plate” is to be interpreted broadly within the context of this disclosure. A holding plate typically includes a holding area where receiving elements can be positioned. Specifically, the holding plate may have a plate-like design, although other shapes are also possible. The holding plate can be formed as a single piece with the base element, can be mounted on the base element, or can be connected to the base element indirectly, such as through an additional element.

The upper side of the holding plate is in particular defined as that side of the holding plate which faces the receiving elements in the fixed state. The underside of the holding plate is, analogously, that side which faces away from the upper side of the holding plate.

The at least one receiving element or the plurality of receiving elements can be arranged and/or fixed detachably on the holding plate in any desired manner, for example by a force-fit and/or form-fit connection. In this case, a releasable arrangement in particular designates an arrangement such that the receiving element can be removed from the holding plate and/or is movable in relation to the holding plate and/or other receiving elements. In particular, the receiving element can be displaced on the holding plate and/or rotated along an axis.

The receiving elements can be positioned on the holding plate in various locations and/or orientations. Specifically, there is an area on the holding plate where the receiving elements can be arranged freely. For instance, the receiving elements can be adjusted or moved around on the holding plate.

According to an advantageous development of the invention, a magnet, in particular an electromagnet, is arranged on an underside of the holding plate, and the at least one receiving element consists at least partially of a magnetizable material. An advantage of this is that a releasable arrangement of the receiving elements in different positions and/or orientations on the holding plate can be realized in a simple manner. The receiving elements are attracted and thus fixed by the magnet. The magnet can in particular be arranged in the base element. When using an electromagnet, a magnetic field strength of the magnet can be adjusted in a simple manner by the applied current strength. As a result, the magnet can be operated in a first configuration in which the magnetic field strength is low, so that the receiving elements can be easily positioned.

The magnet can also be operated in a second configuration in which the magnetic field strength is high, so that the receiving elements are fixed. It is also conceivable that a permanent magnet is arranged, the influence of which on the receiving elements can be adjusted by changing the distance from the holding plate.

A support ring is advantageously positioned carefully on the base element. The support ring can, for example, be arranged on the base element in a form-fitting and/or force-fitting manner. An advantage of this is that a plastic blank, for example a plastic plate, which provides the material necessary for producing the dental splint, can be arranged in a simple manner.

The support ring can be arrangeable in a first position, in which the support ring is arranged on the holding plate, and in a second position, in which the support ring is spaced apart from the holding plate. The support ring can be movable, for instance, by a spring mechanism and/or a hydraulic and/or pneumatic arrangement. By pressing on the support ring, the spring force is overcome and/or the pressure in the hydraulics/pneumatics is reduced and the support ring rests against the holding plate. In this position, the receiving elements can be positioned on the holding plate without the support ring interfering with the positioning. If the pressure is not present, the springs push the support ring away from the holding plate and/or the pressure in hydraulics/pneumatics is increased so that the distance of the support ring to the holding plate is greater than the length of the receiving elements. Thus, the plastic blank can be arranged on the support ring and the plastic blank is then located above the receiving elements.

According to a preferred embodiment of the invention, the at least one receiving element is characterized by a circular base surface and/or an angular cross-sectional profile, specifically rectangular. The base surface of the receiving element is defined as the interface that contacts the holding plate in the fixed state of the receiving element. The circular configuration of the base surface permits facile displacement and positioning of the receiving element on the holding plate. The cross-sectional profile of the receiving element is defined as a plane that intersects the receiving element and is parallel to the base surface. A rectangular cross-section enhances the capability for secure engagement and retention by a robotic manipulator. Furthermore, it is envisaged that each receiving element may incorporate an indentation and/or an aperture. These features enable simplified interfacing with a robotic arm, allowing for efficient engagement with the indentation and/or aperture for manipulation and positioning.

It is also possible for a tooth-receiving element to be arranged on the at least one receiving element in a form-fitting and/or force-fitting manner, wherein the tooth-receiving element can preferably have a rectangular, hexagonal and/or cruciform cross section. A connection between the receiving element and the dental template can be established by the tooth receiving element. In particular, the tooth receiving element can be inserted into the receiving element, for example by a snap closure. The dental template can have a receptacle that corresponds to the rectangular, hexagonal and/or cruciform cross section of the tooth receiving element, so that the dental template can be plugged onto the tooth receiving element. The dental template may also incorporate a connecting element that facilitates attachment to the tooth receiving element. This configuration offers the advantage of enabling straightforward arrangement of the dental template on the receiving element. Additionally, it is conceivable that the tooth receiving element can be designed to establish an angle between the dental template and the receiving element. For instance, the tooth receiving element could be engineered with a specific angular orientation. This design consideration allows for the accommodation of tooth inclination as represented by the dental template, thereby enhancing the precision of the fit and alignment during the dental splint production process.

According to a preferred embodiment of the invention, a minimum of 6 receiving elements is arranged, with a preference for at least 8, more preferably at least 10, and particularly at least 12 receiving elements. This configuration allows for the simulation of various dental arrangements using the receiving elements. For instance, the upper or lower jaw of a child with 10 teeth can be replicated, as well as the upper or lower jaw of an adult with 16 teeth, or an adult jaw without wisdom teeth, comprising 14 teeth. Each receiving element can be equipped with a dedicated tooth receiving element, onto which a dental template can be affixed. Notably, multiple and/or all receiving elements can be adjusted independently in terms of position and/or orientation relative to the base element and/or to one another. This flexibility enables the position and/or alignment to be set either discretely, in predetermined positions and/or orientations, or continuously, allowing for any position and/or alignment within a specified range.

A cutting device for severing the dental splint may be integrated into the apparatus for producing the dental splint. Following the thermoforming process of the plastic blank used to create the dental splint, residual material from the plastic blank may adhere to the dental splint. These remnants can be effectively removed by the cutting device, facilitating the detachment of the dental splint. To achieve this, a cutting trajectory can be computed on the thermoformed plastic blank, along which the cutting device will execute its cuts. The cutting device can be operated automatically, potentially by a robotic system. This configuration offers the advantage of enabling the automatic separation of the dental splint from the residual plastic blank immediately after the thermoforming process, thereby enhancing efficiency and reducing manual intervention.

Additionally, a movement device can be arranged on the device, designed for moving the thermoforming device to the device. By means of the device, the molded part is provided for the production of the dental splint. In addition, the device can serve as a base station for further work steps, for example thermoforming or cutting. In order to prevent the thermoforming device and the cutting device from obstructing each other, the thermoforming device can be moved towards and away from the device by a movement device. The movement device can, for example, enable a linear movement of the thermoforming device. In this way, several work steps can be carried out on the device without different devices interfering with each other for further work steps.

To facilitate the positioning and/or operation of the cutting device, an image detection device may be integrated into the system. This device is designed to ascertain the position and/or orientation of at least one receiving element and/or the dental splint. The image detection device can be implemented as a camera, for instance, enabling real-time monitoring and adjustment of the components involved in the dental splint production process. The position and/or orientation of the receiving element can be detected by the image detection device, so that the positioning device can position and/or align the receiving element more accurately. It is also conceivable that the image acquisition device detects the position of the dental splint after thermoforming and can thus determine the trajectory for the movement of the cutting device. For example, the image acquisition device can provide a 2.5-dimensional image.

It is conceivable to implement a granulate system comprising a container filled with granulates and at least one granulate transport device. This transport device is specifically designed to facilitate the movement of granulates from the container into the apparatus and/or from the apparatus back into the container. The container may serve as a storage unit for the granules, which can have a diameter ranging from 1 to 3 mm. Once the receiving elements have been accurately positioned, the granulates can be conveyed from the storage container to the device via the granulate transport device, effectively surrounding the receiving elements. Notably, the device can be filled with granules up to the level of the dental templates of the receiving elements, thereby enhancing the stability and fixation of the receiving elements within the device. Furthermore, the granules serve to prevent the dental splint from adhering to the receiving elements during the thermoforming process. An additional advantage of the granulate system is its ability to collect cutting waste generated during the cutting of the dental splint. Following this process, the granulates can be transported back from the device to the container using the granulate transport device, allowing for the rearrangement of the receiving elements. In this operation, the cutting waste can also be effectively removed along with the granules. It is also feasible to utilize two distinct granulate transport devices: one dedicated to transporting granulates from the container to the device, and the other for transporting granulates from the device back to the container. The granulate transport device may be equipped with one or more channels through which the granules can be efficiently conveyed.

The granulate transport device can have an air pressure generator and a nozzle unit. In particular, if at least two granulate transport devices are provided, two or more granulate transport devices can be supplied with air by an air pressure generator. The term air pressure generator refers in particular to a device that can provide an overpressure and/or underpressure in order to thus transport air through the granulate transport device. The granules can be transported by the air stream. In this case, the air flow and thus the granulate flow through the granulate transport device can be controlled, for example, by means of valves. By operating the granulate transport device by means of air, in particular pneumatically, a transport of the granules can be made possible in one way.

For this purpose, it may be advantageous for the nozzle unit to have an air duct, a granulate duct and a mixing duct for air and granulate. The air channel can be connected to the air pressure generator, the granulate channel can be connected to the container and the mixing channel can be connected to the device. In order to transport the granules from the container into the device, air can be transported into the nozzle unit through the air duct and then out of the nozzle unit through the mixing duct. As a result of the Venturi effect, a negative pressure is created in the granulate channel, so that granules are drawn from the container into the mixing channel. The mixture of air and granules can then be transported to the device. A second granulate transport device with a second nozzle unit can be provided for removing the granules. A negative pressure can be generated by the air pressure generator, which draws air with granules from the mixing channel into the air channel of the nozzle unit. In this case, for example, a filter prevents the granules from entering the air duct. Instead, the granules can be transported back into the container through the granule channel. An advantage of this is that the granules can be transported from the container and into the container in a simple manner.

Above this all, a holding device for the at least one receiving element can be arranged. The positioning device can receive the receiving element from the holding device and position it on the holding plate. The advantage of this is that a defined starting position of the holding elements is present, so that the positioning of the receiving elements can take place more precisely.

In the method according to the invention for producing a dental splint, the dental templates can be produced by means of 3D printing, in particular with a receptacle and/or a connecting element for connection to the receptacle elements. By 3D printing, the dental templates can be produced in a fast and cheap way. In addition, the receptacle and/or the connecting element in the dental templates, which can be used for connection to the receptacle elements, can be introduced directly during the printing process. As a result, the dental templates can be produced more quickly. To produce the dental templates, an image and/or a digital impression of a dentition can be determined and a 3D model of the dentition can be calculated from this. Subsequently, all parts of the dentition that are not teeth are removed, for example, the jawbones. Thus, only the teeth remain in the 3D model. Receptacles and/or connecting elements are introduced into the teeth. The dental templates can then be printed based on the 3D model of the teeth.

In order to obtain a plan for a positioning and/or arrangement of receiving elements, an image and/or a digital impression of a bite can first be determined. This picture shows the target condition of the dentition for the next treatment phase. The image can be calculated, for example, starting from an actual state of the dentition. Based on the image, the position and/or orientation of the teeth is determined. A plan for the positioning and/or arrangement of the receiving elements is then created. In this context, the intended position and/or arrangement of the dental templates on the receiving elements should correspond essentially to the position and/or arrangement of the teeth as determined from the imaging and/or digital impression. In other words, a predefined movement sequence is established, allowing the positioning device to place the receiving elements in such a manner that the dental templates affixed to the receiving elements are aligned analogously to their respective positions in the dentition. This approach ensures that the resulting splint conforms to the desired anatomical shape.

The placement and fixing of the receiving elements is advantageously carried out on the basis of an image acquisition device, in particular a camera. The image acquisition device can be used to check whether the position of the receiving elements corresponds to the planned position. This improves the accuracy of the positioning.

It is conceivable that the placement and fixation of the receiving elements involves filling the space between the receiving elements with granules. The receiving elements can be positioned within a cavity of the device, and this cavity can be filled with granules until the receiving elements are completely surrounded. An advantage of this method is that it reduces the likelihood of the dental splint adhering to the receiving elements during the thermoforming process, thereby minimizing the risk of sticking.

In an advantageous embodiment, the placement and fixation of the receiving elements may involve adjusting the position and/or orientation of already placed receiving elements. After the production of each dental splint, the position and/or orientation of individual receiving elements can be modified. Given that the adjustment between two positions is minimal, the receiving elements are consequently moved only a short distance, allowing for direct relocation from their current position to the new position. This approach eliminates the need for a complete repositioning of all receiving elements from a fixed defined starting position. As a result, the overall time required for positioning is significantly reduced.

According to an advantageous embodiment, during the thermoforming process of the plastic blank, the plastic blank is initially positioned on the support ring. The support ring may be situated in an elevated position, allowing the plastic blank to be arranged over the receiving elements that hold the dental templates. The plastic blank is then heated and pressed onto the receiving elements, resulting in the thermoforming of the plastic blank into a molded part that conforms to the dental templates. Through this thermoforming process, the shape of the plastic blank is adapted to the contours of the dental templates, thereby producing a dental splint. Subsequently, any residual material from the plastic blank can be removed by cutting away the heated and pressed-in plastic blank.

There are various possibilities for designing and further developing the teachings of the present invention in an advantageous manner. To this end, reference should be made, on one hand, to the claims subordinate to claims 1, 8, and 16, and on the other hand, to the following explanation of preferred exemplary embodiments of the invention with reference to the accompanying drawings. In conjunction with the explanation of the preferred exemplary embodiments of the invention, as illustrated in the drawings, preferred embodiments and developments of the teachings are also discussed in a general context. In the figure:

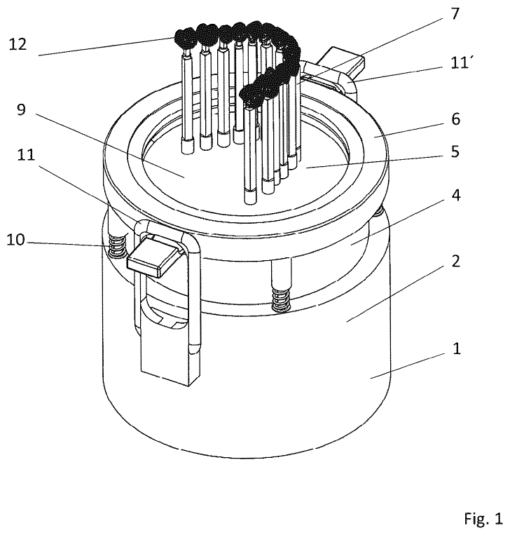

FIG. 1 A base station according to an embodiment of the invention,

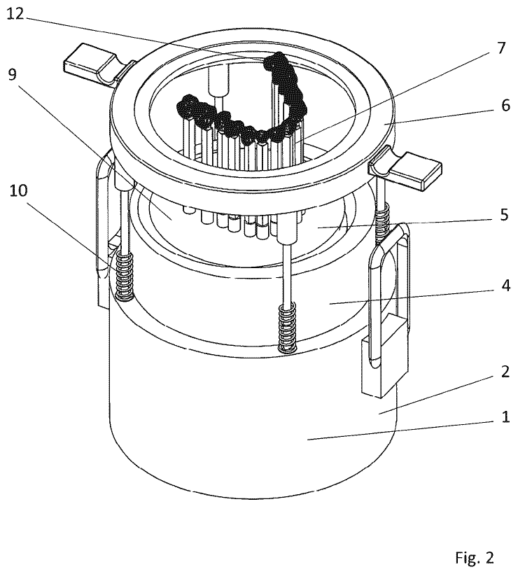

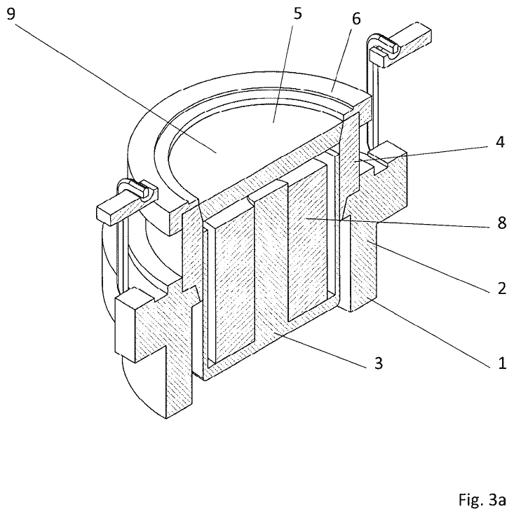

FIG. 2 The base station with increased support ring,

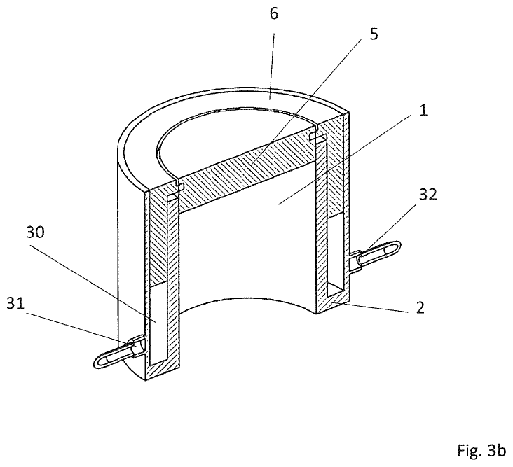

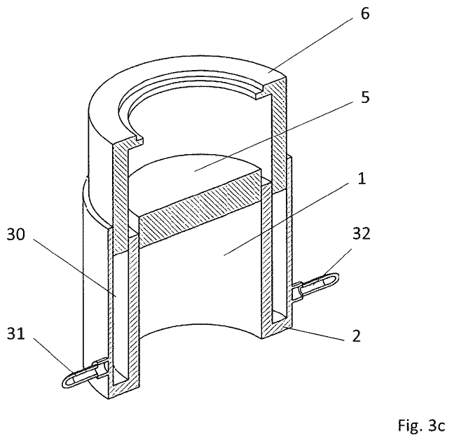

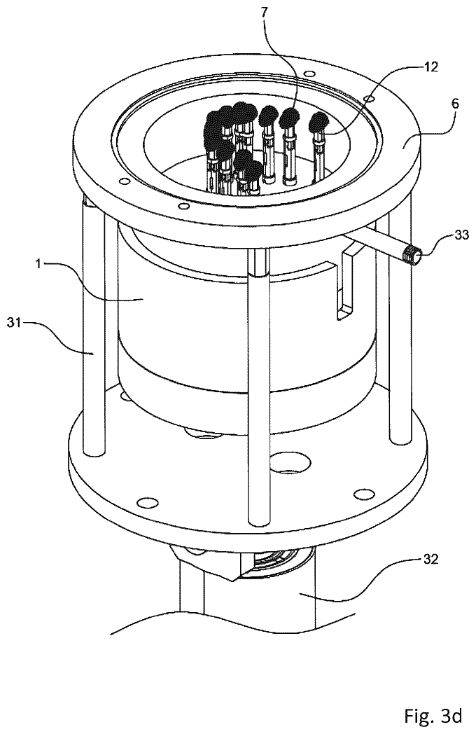

FIG. 3a cross-sectional view of the base station,

FIG. 3b A cross-sectional view of a base station according to a further embodiment of the invention,

FIG. 3c The cross-sectional view of the base station with the support ring extended,

FIG. 3d An embodiment of the base station with a linear actuator,

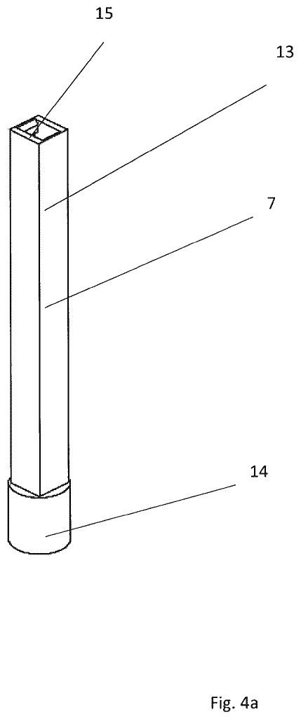

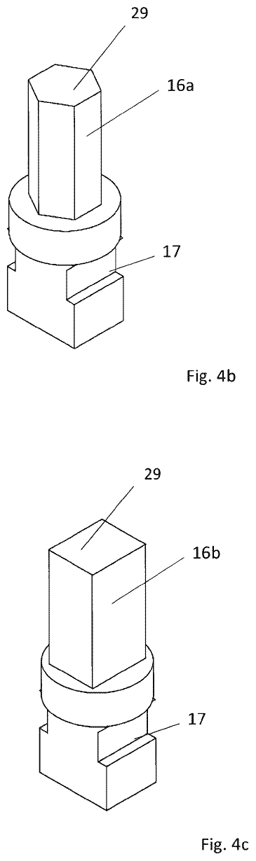

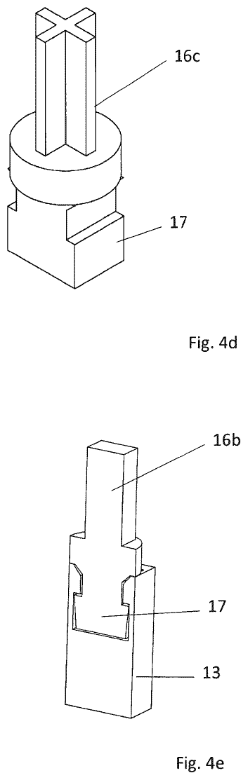

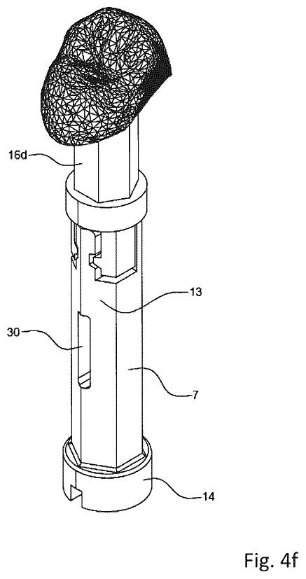

FIG. 4a-f A receiving element and various tooth receiving elements according to an embodiment of the invention,

FIG. 5 A device according to an embodiment of the invention,

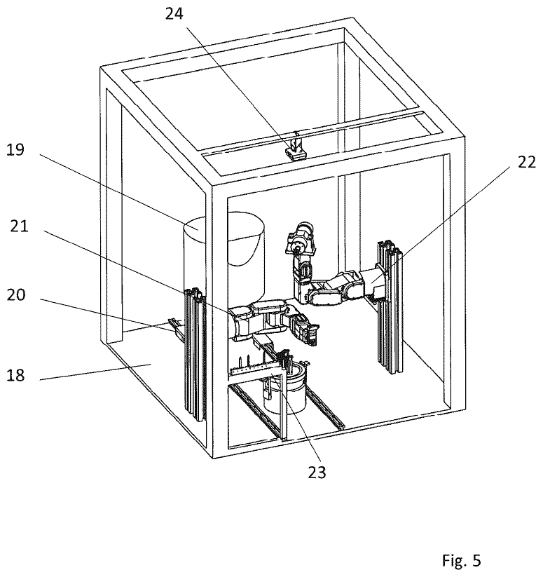

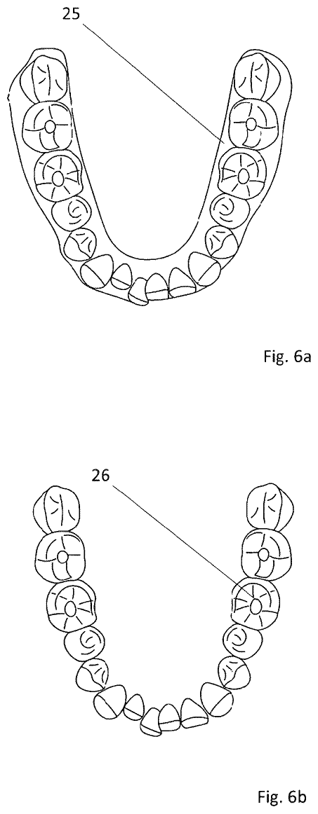

FIG. 6a, b A model of a dentition and a machined model of a dentition according to an embodiment of the invention,

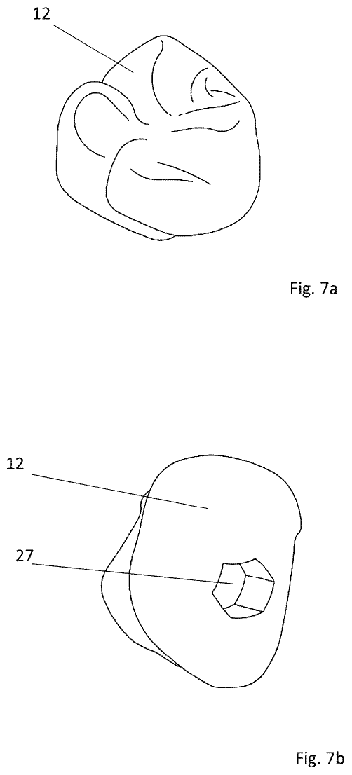

FIG. 7a, b A tooth model according to an embodiment of the invention,

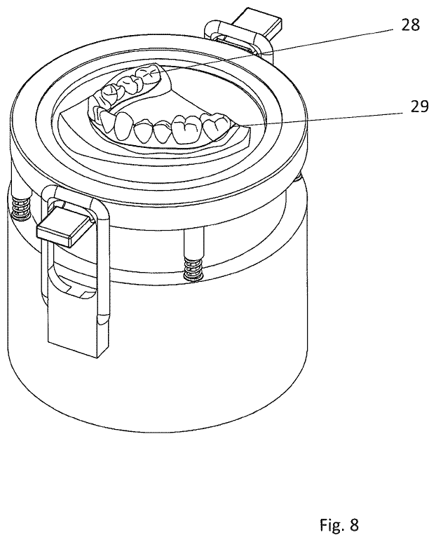

FIG. 8 A dental splint according to an embodiment of the invention,

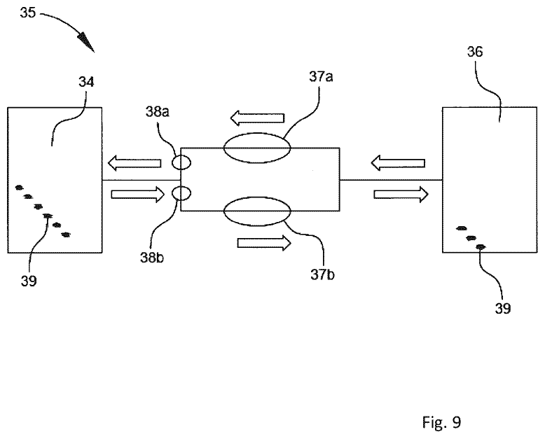

FIG. 9 A granulate system according to an embodiment of the present invention, and

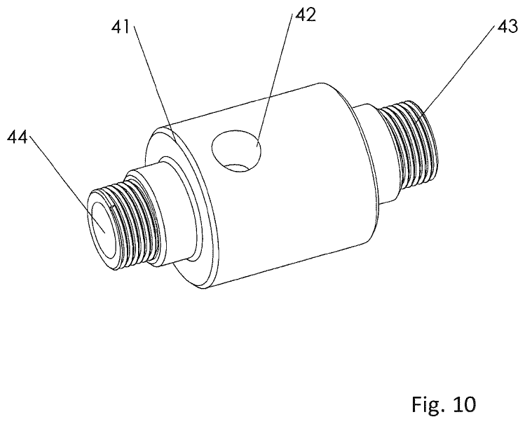

FIG. 10 A nozzle unit according to an embodiment of the present invention.

FIGS. 1 to 3 depicts views of a device 1 for producing a molded part of a dental splint, here in the form of a base station 1. The base station 1 comprises a base element 2, an insert 3, a spacer ring 4, a holding plate 5, a support ring 6 and receiving elements 7. The insert 3 is arranged in the base element 2 and comprises an electromagnet 8. The spacer ring 4 is inserted into the base element 2. The holding plate 5 is arranged on the spacer ring 4. The receiving elements 7 are detachably arranged on the upper side 9 of the holding plate 5.

The support ring 6 can be arranged in two positions. In FIGS. 1 and 3a, the support ring 6 is shown in a lower position, in which the support ring 6 rests against the holding plate 5. The support ring 6 is prestressed by springs 10. Two buckles 11, 11 arranged laterally on the base element 2 prevent the support ring 6 from being pressed into the upper position. In the lower position, the holding plate 5 is freely accessible, so that the receiving elements 7 can be placed on the holding plate 5. In the upper position, a plastic blank can be placed on the support ring 6. By folding the buckles 11, 11 to the side, the support ring 6 can be brought into the upper position. FIG. 2 shows the base station 1, in which the support ring 6 is shown in the upper position.

Dental templates 12 are affixed to the receiving elements 7. The receiving elements 7 can be magnetized and are held in place by the electromagnet 8. Thanks to the precise positioning and alignment of the receiving elements 7, a dentition is simulated by the dental templates 12, which serves as a molded part for the thermoforming process. In particular, the receiving elements 7 can be freely displaced on the holding plate 5, allowing them to be arranged in any position relative to one another and/or relative to the base element 2. Additionally, the receiving elements 7 can be rotated along an axis, enabling various orientations of the receiving elements 7.

FIG. 1 illustrates 14 receiving elements 7, allowing for the reproduction of an adult jaw without wisdom teeth. However, it is also possible to utilize a different number of receiving elements 7, depending on the specific structure of the jaw that is to be reproduced.

A further embodiment of the base station 1 is shown in FIGS. 3b and 3c. In contrast to the base station 1 according to FIGS. 1 to 3a, the support ring 6 is not moved by springs, but by a pneumatic arrangement. The electromagnet can be arranged below the holding plate 5. The support ring 6 is embedded in an opening 30 of the base element 2. Air can be moved in and/or out of the opening 30 through connections 31 and 32. When air is moved into the opening 30, the pressure in the opening 30 increases, causing the support ring to be pressed from the lower position (FIG. 3b) into the upper position (FIG. 3c). Similarly, the pressure drops when the air is released, allowing the support ring to return to the lower position. Due to the high pressure during the thermoforming process, the pneumatic pressure can be overcome, enabling the support ring 6 to be automatically pressed back toward the lower position during thermoforming. It is also conceivable that the support ring is moved hydraulically.

FIG. 3d shows a further embodiment of the base station 1. The support ring 6 is held by a plurality of lateral struts 31, which are connected to a linear actuator 32. The height of the support ring 6 can thus be adjusted by a movement of the linear actuator 32.

Furthermore, an access 33 is arranged at the base station 1. Through this access 33, small granules, for example with a diameter of 1 mm to 3 mm, can be guided by means of air pressure into a cavity 34 of the base station 1 and/or removed from the cavity 34. The granules can be filled into the cavity 34 particularly after the positioning of the receiving elements 7. They are preferably filled to just below the dental templates 12. By utilizing the granules, it is possible to prevent dental splints from sticking to the receiving elements 7 and/or the support ring 6 during the thermoforming process. Additionally, plastic residues or other waste may occur during the cutting process of the dental splint. This waste can fall into the granules and be transported away from the cavity 34 when the granules are removed. The waste can then be disposed of or recycled. The transport of the granules is illustrated in FIG. 9. A receiving element 7 is shown in FIG. 4a. The receiving element 7 comprises a pin 13 with a rectangular cross section. At one end, the receiving element 7 has a cylindrical end piece 14 with a circular base surface. At the other end, the receiving element 7 has an opening 15 into which a tooth receiving element 16a, 16b, 16c can be inserted. FIG. 4 b to 4 d show embodiments of the tooth receiving element. The tooth receiving element 16a, 16b, 16c can have a hexagonal (FIG. 4b), a rectangular (FIG. 4c) or a cross-shaped (FIG. 4d) have an end piece 29, onto which a dental template can be plugged. The base 17 of the tooth receiving element 16a, 16b, 16c can be inserted into the opening 15 of the pin 13 and fixed by a latching mechanism (FIG. 4e).

It is conceivable that different tooth receiving elements 16a, 16b, and 16c are utilized, each featuring an end piece 29 with a different orientation relative to the base 17. This design allows for the realization of various orientations, particularly different angles, of a dental template in relation to the receiving element 7.

FIG. 4f shows a receiving element 7 with a tooth receiving element 16d according to a further embodiment. An opening 30 is formed in the receiving element 7, through which the receiving element 7 can be lifted by a robot arm.

FIG. 5 shows a device 18 for producing a dental splint. The device 18 comprises a base station 1, a thermoforming device 19, a movement device 20, a positioning device 21, a cutting device 22, a holding device 23 and a camera 24.

The positioning device 21 can receive the receiving elements 7 from the holding device 23 and position them on the holding plate 5 of the base station 1. The positioning device 21 is designed as a robot arm to enable precise positioning of the receiving elements 7. A camera 24 is employed for positioning, which checks whether the receiving elements 7 are in the correct position and arrangement. It is conceivable that the robot arm 21 is mounted on a guide, particularly a linear guide, allowing the robot arm 21 to be moved to a predetermined rest position. This capability enables the robot arm 21 to be brought into the rest position while other actions are performed, ensuring that the robot arm 21 does not obstruct these processes. Additionally, this arrangement extends the operational range of the robot arm 21.

With the aid of the movement device 10, the thermoforming device 19 can be moved over the base station 1. After the dental splint has been produced, it is freed from residues of the plastic blank by the cutting device 22. The cutting device 22 is also designed as a robot arm, which can cut automatically around the dental splint. The cutting device 22 can also be controlled by means of data from the camera 24. The camera 24 is arranged above the base station 1. It is also possible to arrange the camera 24 in front of the thermoforming device 19. As a result, 3D data of the teeth can be determined while the thermoforming device 19 is moved by the movement device 10.

It is also conceivable that the cutting device 22 is designed as a 5-axis cutting device. In this configuration, a separate robot arm can be eliminated, and the cutting device can be replaced by a CNC cutting device, allowing for enhanced precision and versatility in the cutting process.

The method for producing a dental splint is outlined as follows:

First, an image of a dentition including a jaw is determined by a patient, for example by a bite impression, which is then digitized, or by direct scanning of the oral cavity of the patient. A CAD model 25 of the bite is calculated from the image. Such a CAD model 25 for a lower jaw is shown in FIG. 6 a. Subsequently, a concept for correcting the position and alignment of the teeth is determined. For this purpose, a target state of the teeth is defined and divided into several phases, An intermediate target state is defined for each phase, with each phase lasting approximately two weeks. A CAD model 25 is created for each intermediate target state, representing the desired condition at the end of that phase and serving as a reference for the corresponding dental splint. Following this, parts of the CAD model 25 that do not depict teeth, such as the jawbones, are removed, resulting in a model that displays only the teeth, referred to as CAD model 26. A processed CAD model 26 is illustrated in FIG. 6b. For each processed CAD model 26, the position and orientation of the teeth are determined and stored. This includes not only the position but also the rotation, inclination, and/or torsion of each tooth. To facilitate easier identification, a unique number, along with its corresponding position and orientation, can be assigned to each tooth.

Starting from the first processed CAD model 26, which shows the actual state of the patient's dentition, dental templates 12 of all teeth are printed in a 3D printer. In contrast to the prior art, it is sufficient to print these dental templates 12 only for the first CAD model 26 and not for all. In this case, the dental templates 12 are provided directly with a receptacle 27, so that they can be plugged onto the receptacle elements 7, by means of the dental receptacle elements 16a, 16b, 16c. A dental template 12 is shown in FIGS. 7a and 7b. After printing the dental templates 12, they can be polished, cleaned and hardened.

The dental templates 12 are inserted onto the tooth receiving elements 16a, 16b, 16c and the tooth receiving elements 16a, 16b, 16c are locked in the receiving elements 7. The receiving elements 7 are then arranged in the holding device 23, which in turn is fixed in the vicinity of the positioning device 21. A plan for the positioning of the receiving elements 7 is determined, starting from the position and orientation of the teeth in a machined CAD model 26. The support ring 6 is fixed in the lower position and the electromagnet 8 generates a magnetic field. The magnetic field is initially weak. The robot arm of the positioning device 21 grips the receiving elements 7 and places them on the holding plate 5. Due to the weak magnetic field, the receiving elements 7 remain in their position, but can be moved by the positioning device 21. The position and orientation of the receiving elements 7 is set according to the specifications of a current CAD model—i.e. on the basis of the plan for positioning. This means that the position and orientation of the dental templates 12 on the receiving elements 7 correspond to the position and orientation of the teeth in the current CAD model. As soon as all the receiving elements 7 are arranged in the correct position on the holding plate 5, the magnetic field strength of the electromagnet is increased, so that the receiving elements 7 are fixedly fixed on the holding plate 5.

The support ring 6 is positioned in the upper position, and a plastic blank is placed on the support ring 6. This plastic blank will later be formed into a transparent dental splint and may be made from materials such as polyvinyl chloride, polyurethane, polyethylene terephthalate (PET), or polyethylene terephthalate glycol. As a result, the plastic blank is situated above the dental templates 12, ready for the subsequent thermoforming process that will shape it into the desired dental splint.

The thermoforming device 19 is then moved over the base station 1 using the movement device 20. Once in position, the thermoforming device 19 heats the plastic blank while simultaneously pressing it onto the dental templates 12. This process allows the plastic blank to conform to the shape of the dental templates 12, which act as a molded part during the thermoforming process. Consequently, a dental splint 28 is created, accurately reflecting the contours of the dental templates.

There are still remnants of the plastic blank on the dental splint 28. For this reason, the support ring 6 is moved back into the lower position, so that access to the dental splint 28 is facilitated. The cutting device 22 then cuts off the remains of the plastic blank from the dental splint 28. For this purpose, a trajectory 29 is calculated, which a cutting head of the cutting device 22 travels. The correct cutting of the cutting device 22 can be monitored and controlled by the camera 24. After that, the splint can be polished, hardened, deburred and removed.

A next dental splint is then produced. For this purpose, a next CAD model 26 is loaded and the new position and orientation of all receiving elements 7 is determined. Since the receiving elements 7 are already in a similar position, the positioning device can push or rotate the receiving elements 7 on the holding plate 5 into the correct position and orientation. Then the next dental splint is produced analogously to the method described at the beginning.

This process is repeated until all the required splints are manufactured according to the CAD models.

FIG. 9 shows a granulate system according to an embodiment of the present invention.

The granulate system 35 consists of a main tank 34 and a container 36, which is configured as a container in this instance. The main tank 34 can specifically be a cavity within the base station 1, as illustrated in FIG. 3d. Granules 39, which may have a diameter of approximately 2 to 3 mm or about 1 to 2 mm, are housed in both the main tank 34 and the container 36. The granules 39 can be transported between the main tank 34 and the storage container 36 using two granulate transport devices 37a and 37b, facilitating efficient movement and management of the granules within the system. The granulate transport devices 37a and 37b can be designed as compressed air transporters that utilize pneumatics to move the granules 39. For instance, one granule transport device 37a can transport granules 39 from the storage container 36 into the main tank 34, while the other granule transport device 37b can move granules 39 from the main tank 34 back into the storage container 36. The inflow and outflow from the container 36 can be regulated using two valves 38a and 38b. Both granulate transport devices 37a and 37b can be supplied with air from a common air pressure generator (not shown), which is capable of providing both overpressure and underpressure. Alternatively, it is also conceivable for each granulate transport device 37a and 37b to have its own dedicated air pressure generator. Additionally, the container 36 may feature an opening 40 to facilitate air pressure equalization, ensuring smooth operation of the granulate transport system.

FIG. 10 shows a nozzle unit according to an embodiment of the present invention.

The nozzle unit 41 can be part of the granulate transport device 37a, 37b according to FIG. 9. The nozzle unit 41 can have an air channel 42, a granulate channel 43 and a mixing channel 44, wherein an air-granulate mixture can be transported through the mixing channel 44. When air flows from the air duct 42 into the mixing duct 44, a negative pressure is created, which transports granules from the granule duct 43 into the mixing duct 44. For this purpose, the granulate channel can be connected to the container 36 according to FIG. 9.

For further advantageous embodiments of the teaching according to the invention, reference is made to the general part of the description and the appended claims to avoid repetitions. These references provide additional details and variations that enhance the understanding and application of the invention, highlighting its versatility and potential for adaptation in various contexts.

To conclude, it should be expressly noted that the exemplary embodiments of the teaching according to the invention described above are intended solely for the purpose of illustrating the claimed teaching and do not serve to limit it to these specific examples. The invention encompasses a broader range of applications and variations that may not be explicitly detailed in the exemplary embodiments, allowing for flexibility and innovation within the scope of the claims.

### REFERENCE SYMBOL LIST

1 Base station
2 Base element
3 Insert piece
4 Spacer ring
5 Holding plate
6 Support ring
7 Receiving elements
8 Electromagnet
9 Top of the holding plate
10 Springs
11 Buckles
12 Dental templates
13 Pin
14 Cylindrical end piece
15 Opening of the pin
16 Tooth receiving element
17 Base of the tooth receiving element
18 Device
19 Thermoforming device
20 Movement device
21 Positioning device
22 Cutting device
23 Holding device
24 Camera
25 CAD Model
26 Processed CAD model
27 Reception of the dental template
28 Dental splints
29 End fitting
30 Aperture
31 Struts
32 Linear actuator
33 Access
34 Cavity
35 Granulate system
36 Container
37a, b Granulate transport devices
38 Valve
39 Granule
40 Opening
41 Nozzle unit
42 Duct
43 Granulate channel
44 Mixing channel

1. A device for producing a molded part of a dental splint comprising a base element, a holding-plate plate, and at least one receiving element, wherein the at least one receiving element is detachably arranged on an upper side of the holding plate wherein the at least one receiving element is designed to receive a dental template and wherein the at least one receiving element is fixable/securable to the holding plate in multiple positions and/or orientations.

2. The device according to claim 1, wherein a magnet, in particular an electromagnet, is arranged on an underside of the holding plate and that the at least one receiving element consists at least partially of a magnetizable material.

3. The device according to claim 1, wherein a support ring is arranged on the base element.

4. The device according to claim 3, wherein the support ring can be arranged in a first position, in which the support ring is arranged on the holding plate and in a second position, in which the support ring is spaced apart from the holding plate.

5. The device according to claim 1, wherein the at least one receiving element has a circular base surface and/or an angular, in particular rectangular, cross-sectional surface.

6. The device according to claim 1, wherein a tooth-receiving element is arranged on the at least one receiving element in a form-fitting and/or force-fitting manner, wherein the tooth-receiving element 16 preferably has a rectangular, hexagonal and/or cruciform cross section.

7. A device according to claim 1, wherein at least 6, preferably at least 8, preferably at least 10, in particular at least 12 receiving elements are arranged.

8. A device for producing a dental splint comprising a device according to claim 1, a positioning device for positioning the at least one receiving element and a thermoforming device for thermoforming a plastic blank.

9. The device as claimed in claim 8, wherein a cutting device is arranged for cutting the dental splint.

10. The device as claimed in claim 8, characterized wherein a movement device is arranged, designed for moving the thermoforming device to the device.

11. An apparatus according to claim 8, wherein an image detection device is arranged, configured for detecting the position and/or the orientation of the at least one receiving element and/or the dental splint.

12. An apparatus according to claim 8, wherein a granule system comprising a container with granules and at least one granule transport device is arranged, wherein the at least one granule transport device is designed to transport granules from the container into the device and/or from the device into the container.

13. The apparatus as claimed in claim 12, wherein the at least one granule conveying device has an air pressure generator and a nozzle unit.

14. The apparatus as claimed in claim 13, wherein the nozzle unit has an air duct, a granulate duct and a mixing duct for air and granulate.

15. The apparatus according to claim 11, wherein a holding device is arranged for the at least one receiving element.

16. A method for producing a dental splint by means of a device according to claim 8, comprising the steps of:
obtaining a plan for a positioning and/or arrangement of receiving elements, wherein a dental template is arranged on each of the receiving elements
placing and fixing the receiving elements on a top of a holding plate on the basis of the received plan, and
production of the dental splint by thermoforming a plastic blank, wherein the placed receiving elements are used as a molded part for thermoforming.

17. The method as claimed in claim 16, wherein the dental templates are produced by means of 3D printing, in particular with a receptacle and/or a connecting element for connection to the receptacle elements.

18. The method as claimed in claim 16, wherein obtaining a plan for a positioning and/or arrangement of receiving elements comprises the following steps:
obtaining an image and/or digital impression of a dentition,
determining the position and/or the alignment of the teeth from the image obtained and/or the digital impression, and
creating a plan for the positioning and/or arrangement of the receiving elements, wherein the planned position and/or arrangement of the dental templates of the receiving elements essentially corresponds to the position and/or arrangement of the teeth determined from the image and/or the digital impression.

19. The method according to claim 16, wherein the placement and fixing of the receiving elements comprises the following steps:
adjusting a magnetic attraction force of a magnet, in particular an electromagnet, wherein the magnet is arranged on a bottom side of the holding plate
placing the receiving elements on the upper side of the holding plate with a specific position and/or orientation, the position and orientation being carried out on the basis of the plan obtained, and
increasing the magnetic attraction of the magnet.

20. The method according to claim 16, wherein the placement and fixing of the receiving elements takes place on the basis of an image capturing device, in particular a camera.

21. A The method according to claim 16, wherein the placement and fixing of the receiving elements comprises changing the position and/or orientation of already placed receiving elements.

22. The method according to claim 16, wherein the placement and fixing of the receiving elements comprises filling a space between the receiving elements with granules.

23. The method as claimed in claim 16, wherein the thermoforming of a plastic blank comprises the following steps:
placing the plastic blank on a support ring,
heating the plastic blank,
pressing the plastic blank onto the placed receiving elements, and
cutting open the heated and pressed-in plastic blank.
